(19) United States
(12) Patent Application Publication
(10) Pub. No.: US 2015/0152906 A1
(43) Pub. Date: Jun. 4, 2015

(54) STUD

(71) Applicant: Giga-Byte Technology Co., Ltd., New Taipei City (TW)

(72) Inventors: Chih-Ming Lai, New Taipei City (TW); Chung Wei Chiang, New Taipei City (TW)

(73) Assignee: Giga-Byte Technology Co., Ltd., New Taipei City (TW)

(21) Appl. No.: 14/197,049

(22) Filed: Mar. 4, 2014

(30) Foreign Application Priority Data
Dec. 2, 2013 (TW) 102222612

(51) Int. Cl. F16B 23/00

(52) U.S. Cl. CPC F16B 23/0007

(57) ABSTRACT

A stud used to support a circuit board on a case, the case has a tapped hole, and the circuit board has a locating hole. The stud includes a main body. The main body includes a screw thread portion and a carrying surface, wherein the main body is fixed to the tapped hole of the case by the screw thread portion, and the carrying surface withstands the circuit board, the carrying surface has an opening and a tooling groove, the opening is corresponding to the locating hole of the circuit board. A hand tool is inserting into the tooling groove of main body, and the shape of the hand tool corresponds to the shape of the tooling groove, so that the main body is able to be fixed to the case or detached from the case by the hand tool.

### CROSS-REFERENCES TO RELATED APPLICATIONS

This non-provisional application claims priority under 35 U.S.C. §119(a) on Patent Application No. 102222612 filed in Taiwan, R.O.C. on Dec. 02, 2013, the entire contents of which are hereby incorporated by reference.

### BACKGROUND OF THE DISCLOSURE

1. Field of the Invention

The disclosure relates to a stud, and more particularly to a stud with a tooling groove for fixing a circuit board.

2. Description of Related Art

The electronic devices set different sizes of studs on the cases, and these studs are used to support the circuit boards or the interface cards, so that the circuit board and the interface card can keep at a position, and the elements of the bottom of the circuit board/interface card will not be pressed to the case, also the circuit board/interface card can be located and fixed on the case of electronic device that to ensure each circuit board or interface card can operate normally.

Most of the studs can be rotated to fixed to the case or detached from the case by fingers, and do not need to use the hand tool that is more convenient. However, if the studs need to be disposed in a narrow place or the both sides of the studs have the high components, it causes the stud can not be rotated smoothly by fingers, and more difficult to fix or detach the studs, also may be hurting the fingers easily.

Another studs, a tool head is required when fixed or detached the studs, the tool head is combined with stud, and the hand tool is inserting into the tool head, so as to fix or detach the stud by hand tool. This stud solves the issue that is difficult to fix or detach the stud.

However, due to the above studs which must be combined with the tool head to fix or detach the stud by the hand tool, such that the operation procedure is troublesome and time-consuming, and must be making the tool heads for various sizes, Therefore, the user can not be operating intuitively, which can not be fixed or detached easily and quickly, also increased the production costs. Besides, some inconvenience may be generated if the tool heads are lost.

Therefore, how to make the stud fixed or detached, that can be selectively by using fingers or hand tool according to the user requirement and simple operation procedures is an important issue for the manufactures of studs.

### SUMMARY OF INVENTION

In view of the above problems, this disclosure provides a stud with a tooling groove, in which the stud can be fixed to the case or detached from the case by a hand tool, so as to solve the above problems.

In one or more embodiments, a stud used to support a circuit board on a case, the case has a tapped hole, and the circuit board has a locating hole. The stud includes a main body. The main body includes a screw thread portion and a carrying surface, wherein the main body is fixed to the tapped hole of the case by the screw thread portion, and the carrying surface withstands the circuit board, the carrying surface has an opening and a tooling groove, the opening is corresponding to the locating hole of the circuit board. A hand tool is inserting into the tooling groove of main body, and the shape of the hand tool corresponds to the shape of the tooling groove, so that the main body is able to be fixed to the case or detached from the case by the hand tool.

Through the present invention, the stud with the tooling groove can be selectively by using fingers or the hand tool according to the user requirement, such that the stud can be fixed to the case or detached from the case in two ways, and that is more utilization and convenience. Furthermore, each stud is able to be directly fixed to the case or detached from the case by the screwdriver, so that the operation procedure is simple and convenient, thus the user can be operating intuitively and quickly, such that the production efficiency is improved.

The detail of this disclosure can be better appreciated from the following detailed description of this disclosure, taken in conjunction with the attached drawings.

### BRIEF DESCRIPTION OF THE DRAWINGS

This disclosure will become more fully understood from the detailed description given herein below for illustration only, and thus not limitative of this disclosure, wherein:

FIG. 1 is an exploded view of the studs and the case according to a first embodiment.

FIG. 2 is a perspective view of the studs fixed on the case by the hand tool according to the first embodiment.

FIG. 3 is an exploded view of the studs and the circuit board according to the first embodiment.

FIG. 4 is a perspective view of the combination of the studs and the circuit board according to the first embodiment.

FIG. 5 is a perspective view of the combination of the studs, the circuit board and an interface card according to the first embodiment.

FIG. 6A is a perspective view of the stud according to the first embodiment.

FIG. 6B is a perspective view of the stud according to a second embodiment.

FIG. 6C to 6E is a perspective view of the stud according to a third embodiment.

### DETAILED DESCRIPTION OF THE DISCLOSURE

This disclosure includes three embodiments. In these three embodiments, a stud 100 will be combined with different appearance of the structure for illustration. People having ordinary skill in the art can make proper modification to the appearance of the stud 100 according to the actual needs or design requirements, not limited as described herein.

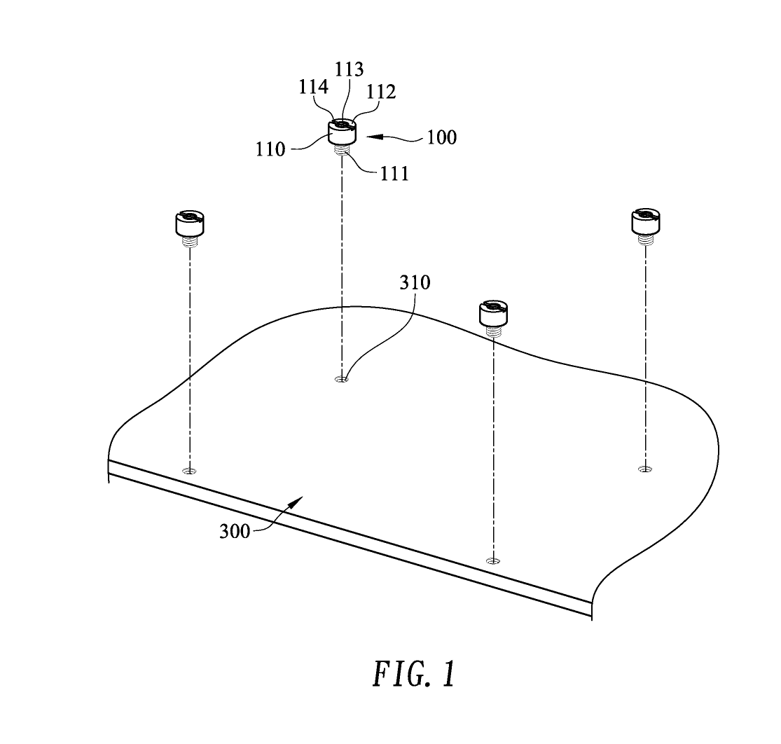

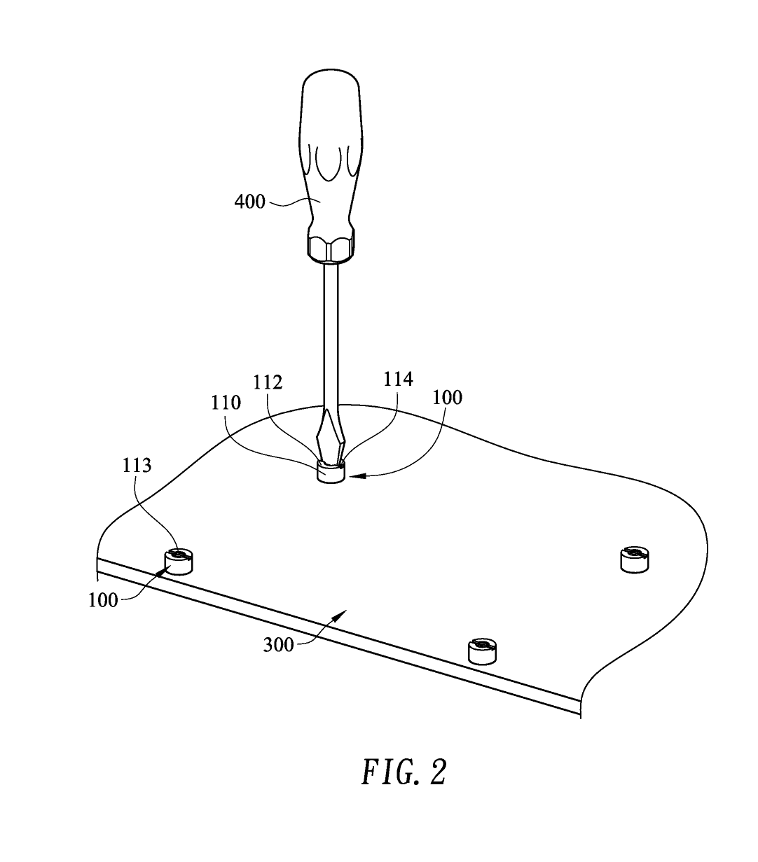

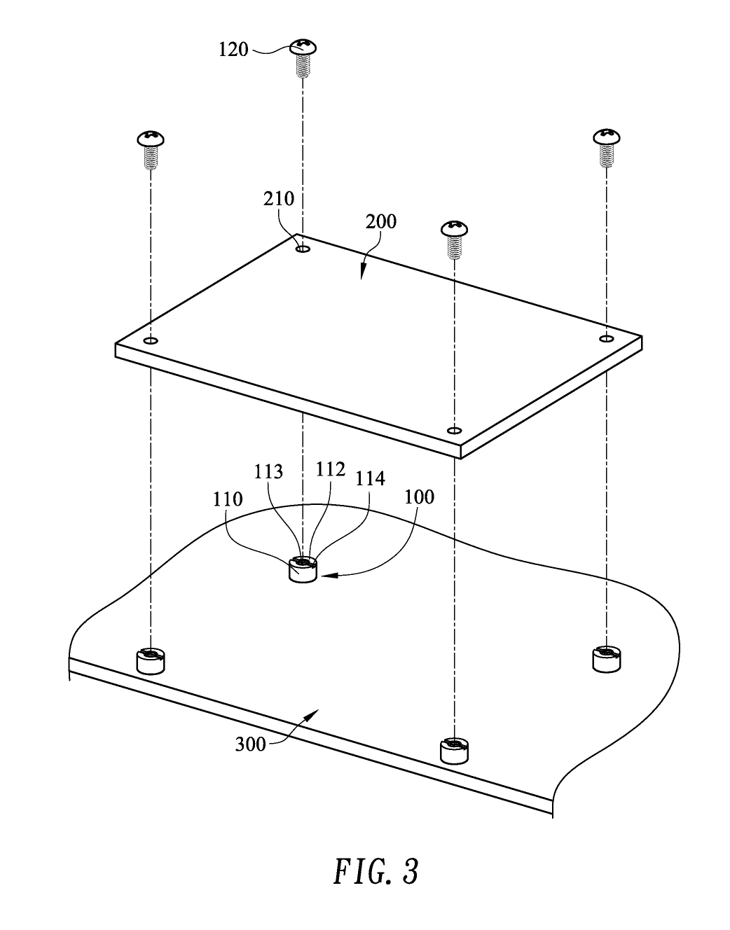

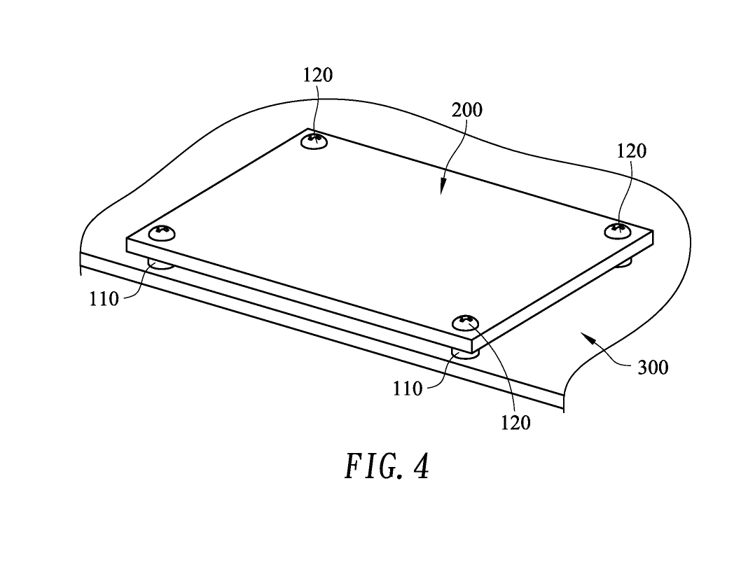

FIGS. 1 to 4 are exploded view and perspective view of the studs 100 of the first embodiment. The stud 100 is used to support a circuit board 200 on the case 300 of an electronic device. The circuit board 200 has a locating hole 210. It is noted that in the following embodiments the circuit board 200 is but not limited to a motherboard. The case 300 of the electronic device is provided with a tapped hole 310, and the motherboard is used as an exemplary interpretation of the studs 100 without any intention to limit the scope of the present invention. The electronic device described in the embodiments, such as a computer host, an all-in-one computer or a notebook. So that the circuit board 200 can keep at a position and having a gap between the circuit board 200 and the case 300 of the electronic device, and the circuit board 200 is steadily fixed and located to the case 300, so that the circuit board 200 can be executing default functions normally.

In this embodiment, the stud 100 includes a main body 110 which can be made of metal, such as copper alloy, aluminum alloy or alloy steel. The main body 110 has a screw thread portion 111 and a carrying surface 112, and the outer diameter of the main body 110 is in the shape of a cylinder. The carrying surface 112 is located at one of the end of the main body 110, and the carrying surface 112 is provided with an opening 113 and a tooling groove 114. The screw thread portion 111 is disposed at the other end of the main body 110. A hand tool 400 is inserting into the tooling groove 114 of the carrying surface 112 of the main body, so as to fix the screw thread portion 111 into the tapped hole 310 of the case 300. Therefore, when the circuit board 200 is disposed on the stud 100, the carrying surface 112 is able to withstand the bottom of the circuit board 200, such that locating hole 210 of the circuit board 200 is able to be corresponding to the opening 113 of the carrying surface 112, so as to provide the positioning function.

Besides, the stud 100 further includes a fixing member 120. The fixing member 120 is penetrated through the locating hole 210 of the circuit board 200 and fixing to the opening 113 of the carrying surface 112 of the main body 110, so that the circuit board 200 is steadily combined with the stud 100, and the circuit board 200 will not be shifted due to the vibration, in order to serve as a support and the position limiting, so that the circuit board 200 can be executing default functions normally. It is noted that in this embodiment the fixing member 120 is but not limited to a screw or a bolt.

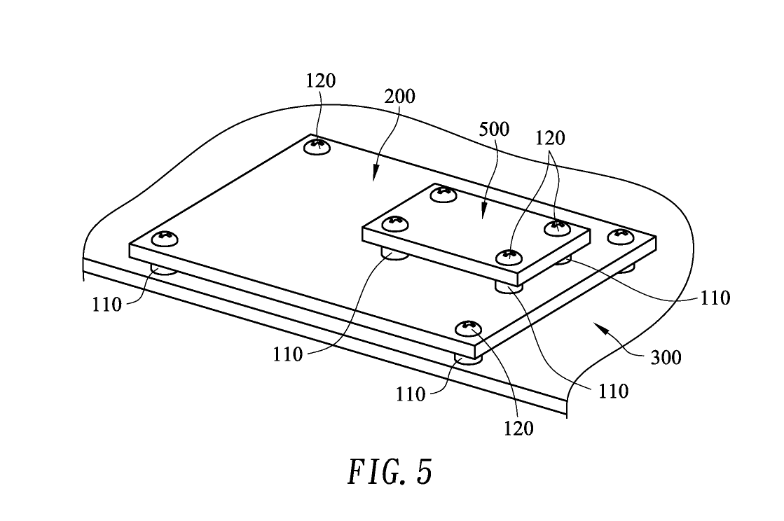

Referring to FIGS. 5, in the first embodiment, in addition to the case 300, the studs 100 also dispose on the circuit board 200 to support an interface card 500, and the interface card 500 can be steadily combined with the stud 100 by the fixing member 120, in order to serve as a support and the position limiting, so that the interface card 500 can be executing default functions normally. It is noted that in this embodiment the interface card 500 is but not limited to a Wi-Fi card, a TV card or a solid state disk.

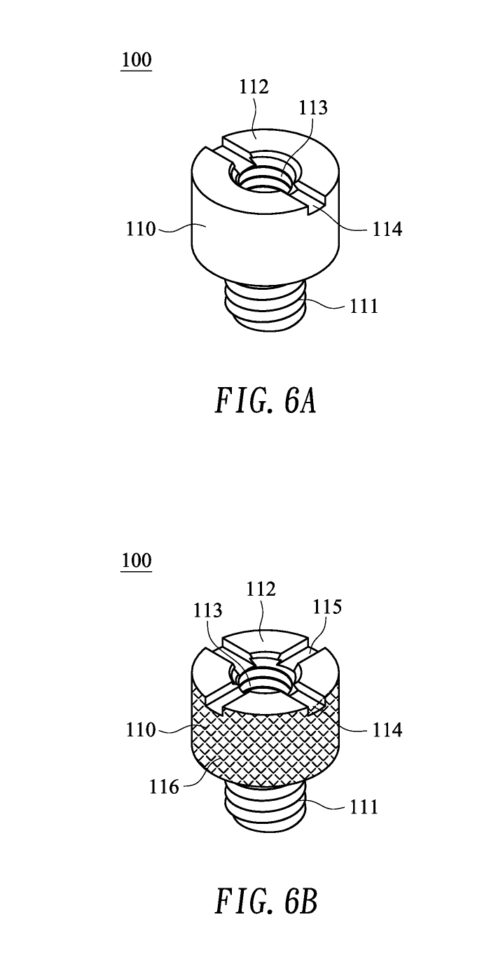

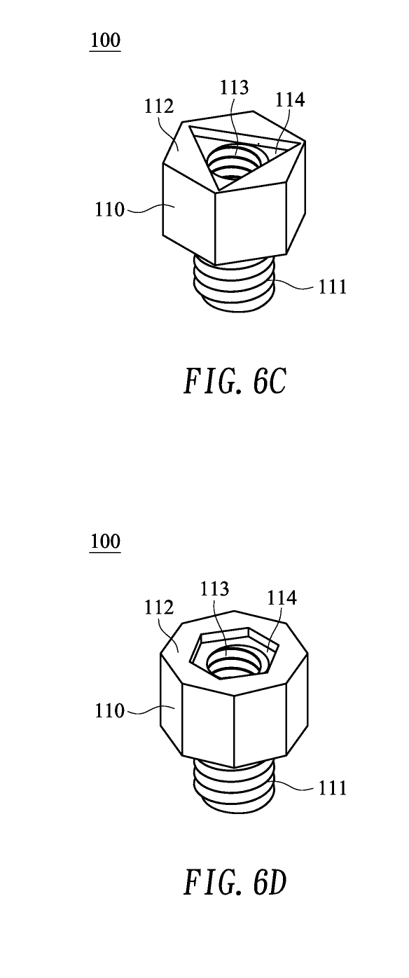

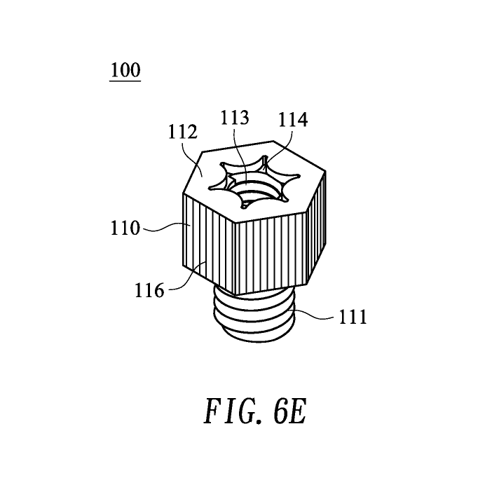

Referring to FIGS. 6A, further explain the structure of the stud 100. The tooling groove 114 is a straight groove. The shape of the end of the hand tool 400 which is inserting into the tooling groove 114 and corresponding to the shape of the tooling groove 114. Therefore, when the hand tool 400 is inserting into the tooling groove 114 of the carrying surface 112, the main body 110 of the stud 100 is driven to rotate by hand tool 400, so as to screw the screw thread portion 111 of the main body 110 into the tapped hole 310 of the case 300 or the circuit board 200, so that the stud 100 is able to be fixed to the case 300 or the circuit board 200.

In contrast, when the main body 110 of the stud 100 is driven to rotate in the opposite direction by hand tool 400, the stud 100 can be detached from the case 300 or the circuit board 200. Based on the above structure, the main body 110 can be directly detached by the hand tool 400, so that the operation procedure is simple and convenient, thus the user can be operating intuitively and quickly.

Referring to FIGS. 6B, in the second embodiment, the main body 110 has a screw thread portion 111 and a carrying surface 112, and the outer diameter of the main body 110 is in the shape of a cylinder. The carrying surface 112 is located at one of the end of the main body 110, and the carrying surface 112 is provided with an opening 113 and a tooling groove 114. The difference between the stud 100 of the second embodiment and the aforementioned embodiments is that the stud 100 further includes another tooling groove 115 which disposed on the carrying surface 112. The tooling groove 114 and the tooling groove 115 are mutually perpendicular, such that the carrying surface 112 is formed with the groove in the shape of a cross. When the hand tool 400 is inserting into the cross shape of the groove of the carrying surface 112, the main body 110 of the stud 100 is driven to rotate by the hand tool 400, so as to fix or detach the stud 100.

Referring to FIGS. 6C to 6E, in the third embodiment, the main body 110 has a screw thread portion 111 and a carrying surface 112, and the outer diameter of the main body 110 is in the shape of a multilateral prism. The carrying surface 112 is located at one of the end of the main body 110, and the carrying surface 112 is provided with an opening 113 and a tooling groove 114. The difference between the stud 100 of the third embodiment and the aforementioned embodiments is that the tooling groove 114 is a polygonal groove, such as a triangular groove, a hexagonal groove or a star groove, and the tooling groove 114 connects with the opening 113. When the hand tool 400 is inserting into the polygonal groove of the carrying surface 112, the main body 110 of the stud 100 is driven to rotate by the hand tool 400, so as to fix or detach the stud 100.

It is noted that in the aforementioned embodiments the hand tool 400 is a screwdriver, wherein the type of head of the hand tool 400 is but not limited to a straight, a cross, a triangle, a hexagonal or a star. The head types of the hand tool 400 are disclosed as described above that is selectively corresponding to different shapes of the tooling grooves 114 according to the aforementioned embodiments, so as to provide more utilization and convenience.

Besides, in the aforementioned embodiments, in order to provide better operability, the outer diameter of the main body 110 is in the shape of a cylinder or a multilateral prism, such as hexagonal prism or octagonal prism, or a surface of the outer diameter of the main body 110 with a texture structure 116, such as horizontal stripes, vertical stripes or plaid stripes, and the surface of the main body 110 has a frictional force, so that the user is easy and quick to fix or detach the stud 100 by fingers.

In the aforementioned embodiments, the shape of the outer diameter of the main body 110 also can be combined the texture structure 116, and the user can mix match the appearance of the stud 100 according to the actual needs or design requirements, not limited as described above.

To sum up, in the aforementioned embodiments, it is clearly described that the present invention solves the existing problems by providing the stud in which with the tooling groove can be selectively by using fingers or hand tool to fix or detach the stud according to the user requirement.

The stud of the present invention achieves that the main body with the tooling groove can be selectively by using fingers or hand tool to fix or detach the stud according to the user requirement, such that the stud can be fixed to the case or detached from the case in two ways, so as to provide more utilization and convenience. Furthermore, each stud is able to be directly fixed to the case or detached from the case by the screwdriver, so that the operation procedure is simple and convenient, thus the user can be operating intuitively and quickly, so that the production efficiency is improved.

The aforementioned descriptions represent merely the preferred embodiment of the present invention, without any intention to limit the scope of the present invention thereto. Various equivalent changes, alterations, or modifications based on the claims of the present invention are all consequently viewed as being embraced by the scope of the present invention.

What is claimed is:

1. A stud, used to support a circuit board on a case, wherein the case has a tapped hole, and the circuit board has a locating hole, comprising:
a main body having a screw thread portion and a carrying surface, wherein the main body is fixed to the tapped hole of the case by the screw thread portion, and the carrying surface withstands the circuit board, the carrying surface has an opening and a tooling groove, the opening is corresponding to the locating hole of the circuit board;
wherein a hand tool is inserting into the tooling groove of the main body, and the shape of the hand tool is corresponding to the shape of the tooling groove, so that the main body is able to be fixed to the case or detached from the case by the hand tool.

2. The stud as claimed in claim 1, wherein the tooling groove is a straight groove.

3. The stud as claimed in claim 1, wherein the carrying surface of the main body further comprises another tooling groove, the tooling grooves are mutually perpendicular.

4. The stud as claimed in claim 1, wherein the tooling groove is a polygonal groove, and the tooling groove connects with the opening.

5. The stud as claimed in claims 1, wherein the outer diameter of the main body is in the shape of a cylinder or a multilateral prism.

6. The stud as claimed in claim 1, wherein the outer diameter of the main body with a texture structure.

7. The stud as claimed in claim 5, wherein the outer diameter of the main body with a texture structure.

8. The stud as claimed in claim 1, further comprising a fixing member, wherein the fixing member is penetrated through the locating hole of the circuit board and fixing to the opening of the carrying surface.

9. The stud as claimed in claims 2, wherein the outer diameter of the main body is in the shape of a cylinder or a multilateral prism.

10. The stud as claimed in claim 9, wherein the outer diameter of the main body with a texture structure.

11. The stud as claimed in claims 3, wherein the outer diameter of the main body is in the shape of a cylinder or a multilateral prism.

12. The stud as claimed in claim 11, wherein the outer diameter of the main body with a texture structure.

13. The stud as claimed in claims 4, wherein the outer diameter of the main body is in the shape of a cylinder or a multilateral prism.

14. The stud as claimed in claim 13, wherein the outer diameter of the main body with a texture structure.
